(19) United States
(12) Patent Application Publication
(10) Pub. No.: US 2024/0178410 A1
(43) Pub. Date: May 30, 2024

(54) SOLID OXIDE CELL STACK

(71) Applicant: SAMSUNG ELECTRO-MECHANICS CO., LTD., Suwon-si (KR)

(72) Inventors: Jeong Suong Yang, Suwon-si, Gyeonggi-do (KR); Byung Chul Jang, Suwon-si, Gyeonggi-do (KR); Jae Hyuk Jang, Suwon-si, Gyeonggi-do (KR); Su Beom Park, Suwon-si, Gyeonggi-do (KR); Jung Hyun Lee, Suwon-si, Gyeonggi-do (KR); Dong Jin Kim, Suwon-si, Gyeonggi-do (KR); Shi Woo Lee, Suwon-si, Gyeonggi-do (KR)

(73) Assignee: SAMSUNG ELECTRO-MECHANICS CO., LTD., Suwon-si (KR)

(21) Appl. No.: 18/219,850

(22) Filed: Jul. 10, 2023

(30) Foreign Application Priority Data
Nov. 28, 2022 (KR) 10-2022-0161976
Dec. 30, 2022 (KR) 10-2022-0190739

(51) Int. Cl. H01M 8/0245; H01M 8/0232; H01M 8/0234; H01M 8/0247; H01M 8/1213; H01M 8/1246; H01M 8/2432

(52) U.S. Cl. CPC H01M 8/0245; H01M 8/0232; H01M 8/0234; H01M 8/0247; H01M 8/1213; H01M 8/1246; H01M 8/2432; H01M 2008/1293

(57) ABSTRACT

A solid oxide cell stack includes first and second interconnects, a solid oxide cell disposed between the first and second interconnects, and a porous metal foam between the first interconnect and the solid oxide cell, wherein the porous metal foam includes a carbon nanostructure formed on a surface thereof.

### CROSS-REFERENCE TO RELATED APPLICATION (S)

This application claims benefit of priority to Korean Patent Application No. 10-2022-0190739 and 10-2022-0161976 filed on Dec. 30, 2022, and Nov. 28, 2022, in the Korean Intellectual Property Office, the disclosure of which is incorporated herein by reference in its entirety.

### TECHNICAL FIELD

The present disclosure relates to a solid oxide cell stack.

A solid oxide fuel cell (SOFC) and a solid oxide electrolysis cell (SOEC) include a cell composed of a solid electrolyte having an air electrode, a fuel electrode, and oxygen ion conductivity, and the cell may be referred to as a solid oxide cell. A solid oxide cell produces electrical energy by electrochemical reactions, or produces hydrogen by electrolyzing water by reverse reactions of the solid oxide fuel cell. The solid oxide cell has low overvoltage based on low activation polarization and has high efficiency due to low irreversible loss as compared to other types of fuel cells or water electrolysis cells, such as a phosphoric acid fuel cell (PAFC), an alkaline fuel cell (AFC), a polymer electrolyte fuel cell (PEMFC), a direct methanol fuel cell (DMFC). Furthermore, because the solid oxide cell may not only be used for a hydrogen fuel but also for a carbon or hydrocarbon fuel, it can have a wide range of fuel choices, and because the solid oxide cell has a high reaction rate in an electrode, it does not require an expensive precious metal as an electrode catalyst.

The solid oxide cell may be used as a stack structure in the form of a pair of interconnects, and in the present disclosure, electrical/structural connectivity between the interconnects and the solid oxide cell needs to be sufficiently secured to improve reliability.

### SUMMARY

An aspect of the present disclosure is to implement a solid oxide cell stack configured to improve electrical and structural connectivity between an interconnect and a solid oxide cell.

In order to solve the above-described issues, according to an aspect of the present disclosure, a solid oxide cell stack includes: first and second interconnects, a solid oxide cell disposed between the first and second interconnects, and a porous metal foam between the first interconnect and the solid oxide cell, wherein the porous metal foam includes a carbon nanostructure formed on a surface thereof.

According to some embodiments of the present disclosure, the carbon nanostructure may include at least one of carbon nanotubes or carbon nanofibers.

According to some embodiments of the present disclosure, the carbon nanostructure may be formed on a surface in contact with the solid oxide in the porous metal foam.

According to some embodiments of the present disclosure, the carbon nanostructure may be formed on a surface opposite to the surface in contact with the solid oxide in the porous metal foam.

According to some embodiments of the present disclosure, the carbon nanostructure may be formed on a surface and an entire interior of the porous metal foam.

According to some embodiments of the present disclosure, the carbon nanostructure may be disposed on the surface of the porous metal foam in a direction perpendicular to the surface of the porous metal foam.

According to an example embodiment of the present disclosure, the carbon nanostructure may be disposed on the surface of the porous metal foam in a random direction with respect to the surface of the porous metal foam.

According to some embodiments of the present disclosure, the porous metal foam may include Ni.

According to some embodiments of the present disclosure, the porous metal foam may be an elastic body, and the porous metal foam may be compressed by the first interconnect and the solid oxide cell.

According to some embodiments of the present disclosure, the solid oxide cell may include a fuel electrode and an air electrode, and an electrolyte disposed between the fuel electrode and the air electrode, and the fuel electrode may be disposed at the first interconnect side, and the air electrode may be disposed at the second interconnect side.

According to some embodiments of the present disclosure, when the porous metal foam is referred to as a first porous metal foam, the solid oxide cell stack may further include a second porous metal foam disposed between the second interconnect and the solid oxide cell.

According to some embodiments of the present disclosure, the second porous metal foam may include a Cu alloy.

According to some embodiments of the present disclosure, the solid oxide cell stack may further includes: first and second end plates, wherein the first and second interconnects, the solid oxide cell, and the porous metal foam are disposed between the first and second end plates. According to some embodiments of the present disclosure, the solid oxide cell stack may have a structure in which the first interconnect, the porous metal foam, the solid oxide cell, and the second interconnect are sequentially and repeatedly formed two or more times, in a direction oriented from the first end plate to the second end plate.

According to some embodiments of the present disclosure, the porous metal foam may further include a protective formed on a surface of the carbon nanostructure.

According to some embodiments of the present disclosure, the protective layer may include at least one of B and Al.

In the case of a solid oxide cell stack according to some embodiments of the present disclosure, reliability may be improved by securing electrical and structural connectivity between an interconnect and a solid oxide cell. Accordingly, when the solid oxide cell stack is used as a fuel cell or a water electrolysis cell, the performance thereof may be improved.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is an exploded perspective view schematically illustrating a solid oxide cell stack according to an example embodiment of the present disclosure;

FIGS. 2 and 3 are cross-sectional views of one region of the solid oxide cell stack;

FIG. 4 is a view illustrating an example in which a metal foam is pressed in the solid oxide cell stack in FIG. 2;

FIGS. 5 to 8 are views illustrating an example of a metal foam that may be used in the solid oxide cell stack;

FIG. 9 is a view illustrating an example of a carbon nanostructure that may be used in the solid oxide cell stack; and

FIGS. 10 and 11 are views illustrating a solid oxide cell stack according to a modified example.

### DETAILED DESCRIPTION

Hereinafter, example embodiments of the present disclosure will be described with reference to specific example embodiments and the attached drawings. The example embodiments of the present disclosure may, however, be exemplified in many different forms and should not be construed as being limited to the specific embodiments set forth herein. The example embodiments disclosed herein are provided for those skilled in the art to better explain the present disclosure. In the drawings, the shapes and dimensions of elements may be exaggerated for clarity, and the same reference numerals will be used throughout to designate the same or like elements.

In order to clearly explain the present disclosure in the drawings, the contents unrelated to the description are omitted, thicknesses of each component are enlarged to clearly express multiple layers and regions, and components with the same function within the same range of ideas are described using the same reference numerals. Throughout the specification, when a certain portion “includes” or “comprises” a certain component, this indicates that other components are not excluded and may be further included unless otherwise noted.

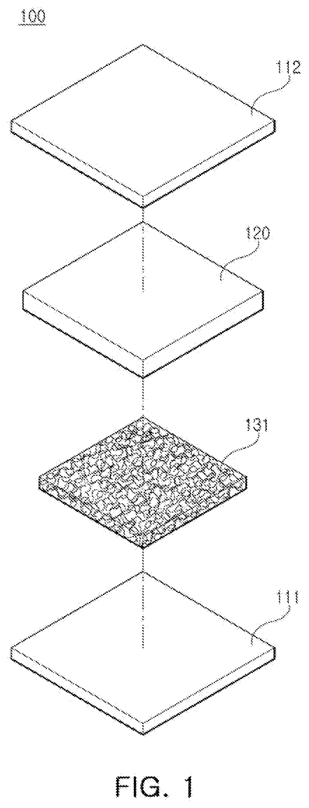

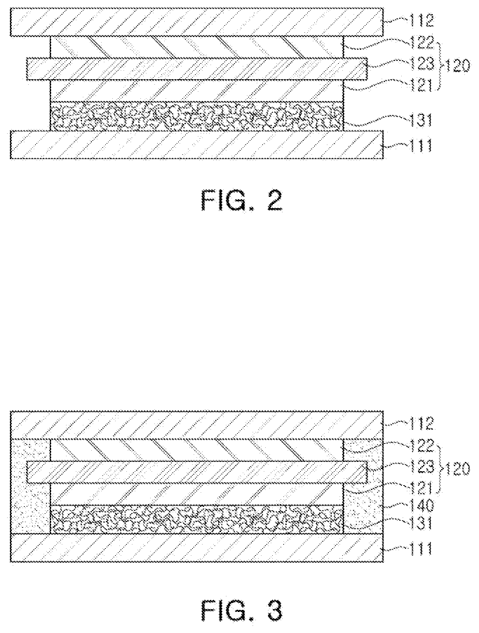

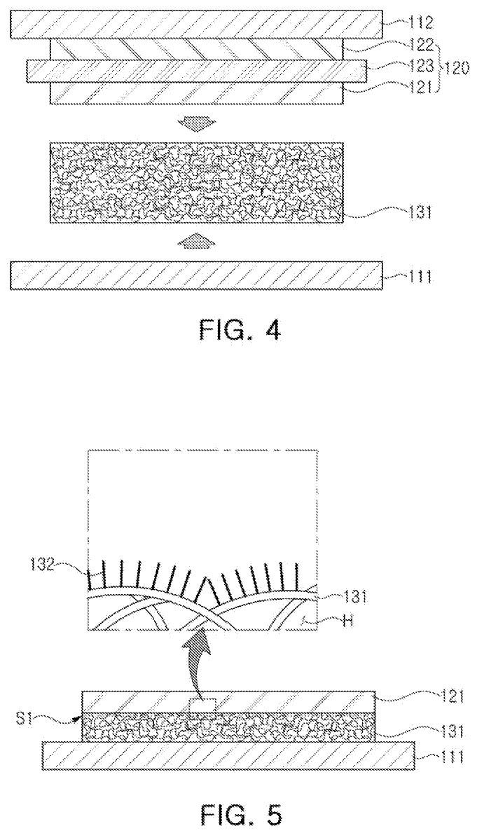

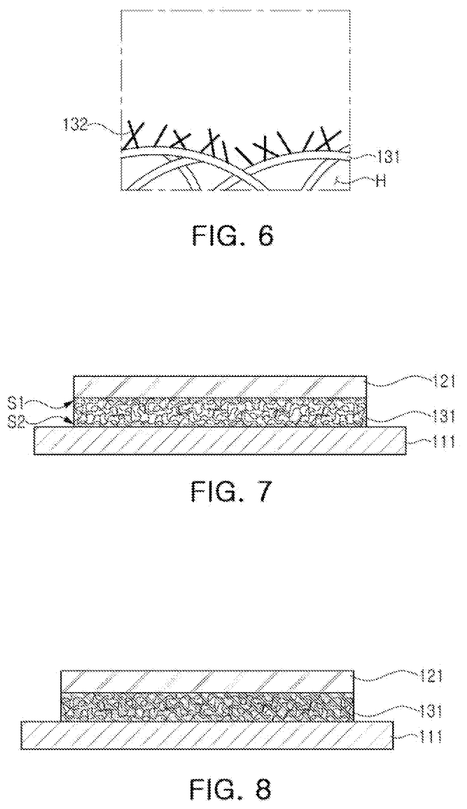

FIG. 1 is an exploded perspective view schematically illustrating a solid oxide cell stack according to an example embodiment of the present disclosure. FIGS. 2 and 3 are cross-sectional views of one region of the solid oxide cell stack. FIG. 4 is a view illustrating an example in which a metal foam is pressed in the solid oxide cell stack in FIG. 2. FIGS. 5 to 8 are views illustrating an example of a metal foam that may be used in the solid oxide cell stack.

Referring to FIGS. 1 to 5, according to some example embodiments of the present disclosure, a solid oxide cell stack 100 may include a first interconnect 111, a solid oxide cell 120, and a second interconnect 112 as major components, and a porous metal foam 131 is disposed between the first interconnect 111 and the solid oxide cell 120. Furthermore, the porous metal foam 131 may include a carbon nanostructure 132 formed on a surface thereof. The carbon nanostructure 132 adopted in this example embodiment may use the porous metal foam 131 formed on a surface thereof to improve electrical/structural connectivity the between first interconnect 111 and the solid oxide cell 120, thereby improving performance and durability of the solid oxide cell stack 100. Hereinafter, the components of the solid oxide cell stack 100 are specifically described, and a case in which the solid oxide cell stack 100 is used as a fuel cell is mainly described. However, the solid oxide cell stack 100 may also be used as a water electrolysis cell, and in this case, in a fuel electrode 121 and an air electrode 122 of the solid oxide cell 120, a reaction opposite to a case of the fuel cell will occur.

The first and second interconnects 111 and 112 may be electrically connected to the solid oxide cell 120, and, for example, when the solid oxide cell stack 100 includes a stacked structure including a plurality of solid oxide cells 120, the solid oxide cell stack 100 may be disposed between adjacent solid oxide cells 120 so that the solid oxide cells 120 are connected to each other. The first and second interconnects 111 and 112 may have a flat plate structure and may also include a flow path and a through-hole through which gas may be diffused. The first and second interconnects 111 and 112 may include a material having excellent electrical conductivity and low degradation in a high-temperature environment. As a specific example, the first and second interconnects 111 and 112 may include a metal such as stainless steel, nickel, iron, or copper.

The solid oxide cell 120 may be disposed between the first and second interconnects 111 and 112 and corresponds to a functional layer of a fuel cell or a water electrolytic cell. Specifically, the solid oxide cell 120 may include the fuel electrode 121 and the air electrode 122, and an electrolyte 123 disposed between the fuel electrode 121 and the air electrode 122. In this case, the fuel electrode 121 may be disposed on a surface of the electrolyte 123 which is closer to the first interconnect 111, and the air electrode 122 may be in contact with the second interconnect 112. When the solid oxide cell 120 is a fuel cell, for example, water production due to oxidation of hydrogen or an oxidation reaction of a carbon compound may occur in the fuel electrode 121, and oxygen ion generation reaction may occur due to oxygen decomposition in the air electrode 122. When the solid oxide cell 120 is a water electrolytic cell, a reaction opposite to the fuel cell may occur, and, for example, hydrogen gas may be generated by a reduction reaction of water in the fuel electrode 121, and oxygen may be generated in the air electrode 122. Furthermore, in the case of the fuel cell, a hydrogen decomposition (hydrogen ion generation) reaction may occur in the fuel electrode 121, and water may be generated by combining oxygen and hydrogen ions in the air electrode 122. In the case of the water electrolytic cell, a water decomposition (hydrogen and oxygen ion generation) reaction occurs in the fuel electrode 121, and oxygen may be generated in the air electrode 122. Furthermore, in the electrolyte 123, ions may move to the fuel electrode 121 or the air electrode 122.

The fuel electrode 121, the electrolyte 123, and the air electrode 122 may include a solid oxide. Specifically, in the case of the fuel electrode 121, a cermet layer including a metal-containing phase and a ceramic phase may be included. Here, the metal-containing phase may include a metal catalyst such as nickel (Ni), cobalt (Co), copper (Cu), or alloys thereof, which acts as an electron conductor. The metal catalyst may be in a metal state or an oxide state. In case that the fuel electrode 121 includes the ceramic phase, the fuel electrode 121 may include gadolinia doped ceria (GDC), samarium doped ceria (SDC), yttria-doped ceria (YDC), scandia stabilized zirconia (SSZ), yttria ceria scandia stabilized zirconia (YbCSSZ).

The electrolyte 123 may include stabilized zirconia. Specifically, the electrolyte 123 may include scandia stabilized zirconia (SSZ), yttria stabilized zirconia (YSZ), scandia ceria stabilized zirconia (SCSZ), scandia ceria yttria stabilized zirconia (SCYSZ), and scandia ceria yttria stabilized zirconia (SCYbSZ).

The air electrode 122 may include an electrically conductive material including an electrically conductive perovskite material such as lanthanum strontium manganite (LSM). Other conductive perovskites, for example, lanthanum strontium cobalt (LSC), lanthanum strontium cobalt manganese (LSCM), lanthanum strontium cobalt ferrite (LSCF), lanthanum strontium ferrite (LSF), and a metal such as La_{0.85}Sr_{0.15}Cr_{0.9}Ni_{0.1}O₃ (LSCN) or Pt may also be used. In some embodiments, the air electrode 122 may include a mixture of an electrically conductive material and an ion conductive ceramic material. For example, the air electrode 122 may include about 10 wt % to about 90 wt % of an electrically conductive material (e.g., LSM, etc.) and about 10 wt % to about 90 wt % of an ion conductive material. Here, the ion conductive material may include a zirconia-based and/or ceria-based material.

Meanwhile, in an example embodiment of FIG. 2, a portion of the solid oxide cell 120 and the porous metal foam 131 are exposed to the outside, but a sealing structure may be added to protect the solid oxide cell 120 and the porous metal foam 131 and prevent gas from leaking. That is, as illustrated in FIG. 3, a sealing portion 140 covering side surfaces of the solid oxide cell 120 and the porous metal foam 131 may be further provided. The sealing portion 140 may include a glass-based material, and in this case, a tissue of the sealing portion may be densified at high temperatures to prevent liquid or gas from leaking. The sealing portion 140 may further include a frame and a gasket structure. Furthermore, according to some example embodiments, an additional sealing portion for sealing the first and second interconnects 111 and 112 may be further provided.

The porous metal foam 131 is disposed between the first interconnect 111 and the solid oxide cell 120 and includes a carbon nanostructure 132 formed on a surface thereof. The porous metal foam 131 may be, for example, in a foam-type metal body structure or a sponge structure entangled with a metal wire. As a more specific example, considering that the fuel electrode 121 may have a reducing atmosphere upon driving the solid oxide cell 120, the porous metal foam 131 may be in a Ni foam form including Ni. The porous metal foam 131 may be an elastic body and may be compressed by the first interconnect 111 and the solid oxide cell 120, as illustrated in FIG. 4. Because the porous metal foam 131 may include pores H therein, the first interconnect 111 and the solid oxide cell 120 may be electrically connected to each other without interfering with a flow of a fuel.

The carbon nanostructure 132 formed on the surface of the porous metal foam 131 may include at least one of a carbon nano tube and a carbon nano fiber. For example, the carbon nanostructure 132 may have a diameter of several nm to several tens of nm and a length of several μm to several mm. As described, the carbon nanostructure 132 may be formed on a surface S1 of the porous metal foam 131 in contact with the solid oxide 120 or a fuel electrode (121) of the solid oxide (120), which may take into account the importance of connectivity at the surface S1 in contact with the solid oxide 120. In FIG. 5, a hatched region of the solid oxide 120 at the surface S1 in contact with the fuel electrode 121 indicates a region in which the carbon nanostructure 132 is formed. Furthermore, as illustrated in FIG. 7, the carbon nanostructure 132 may also be formed on a surface S2 of the porous metal foam 131 opposite to the surface S1 in contact with the first interconnect 111. Furthermore, as illustrated in FIG. 8, the carbon nanostructure 132 may be formed on a surface and an entire interior of the porous metal foam 131.

Referring to an enlarged region of the surface S1 in FIG. 5, the carbon nanostructure 132 may be vertically disposed with respect to the surface of the porous metal foam 131. The vertical arrangement method may be achieved by growing the carbon nanostructure 132 on the surface of the porous metal foam 131. Here, the growth of the carbon nanostructure 132 may be formed by a method such as chemical vapor deposition or thermal vapor deposition. Furthermore, as another example, as illustrated in FIG. 6, the carbon nanostructure 132 may be disposed in a form inclined in a random direction with respect to the surface of the porous metal foam 131. The configuration of the random arrangement may be achieved by attaching a pre-produced carbon nanostructure 132 to the surface of the porous metal foam 131.

As in this example embodiment, when the porous metal foam 131 having the carbon nanostructure 132 is disposed between the first interconnect 111 and the solid oxide cell 120, electrical properties and structural stability of the solid oxide cell stack 100 may be improved. When the solid oxide cell stack 100 is driven, a deformation thereof due to vibration may reduce the connectivity between the first interconnect 111 and the solid oxide cell 120, but the porous metal foam 131 may maintain the connectivity between the first interconnect 111 and the solid oxide cell 120 even in such environments, and the porous metal foam 131 may include a plurality of pores H, thereby enabling the fuel and the like to pass through the porous metal foam 131. To this end, as described above, the porous metal foam 131 may have elasticity. Furthermore, because the carbon nanostructure 132 is formed on the surface of the porous metal foam 131, electrical resistance between the first interconnect 111 and the solid oxide cell 120 may be further lowered. Furthermore, the carbon nanostructure 132 may be oriented in various directions, which may further improve resistance to mechanical deformation or contamination.

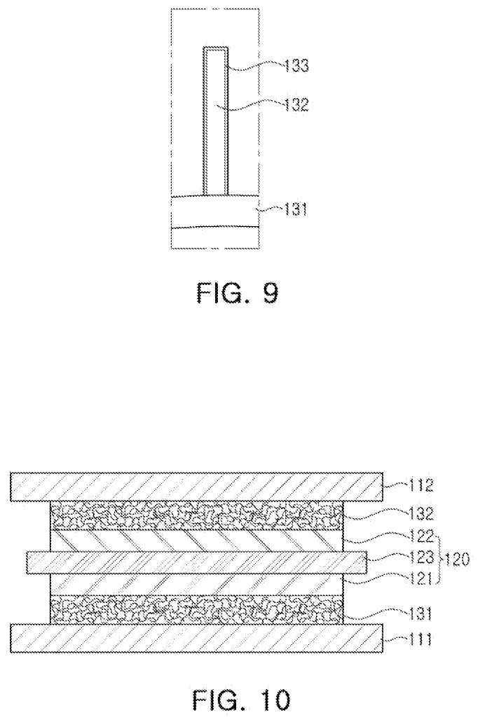

Meanwhile, as illustrated in FIG. 9, the porous metal foam 131 may further include a protective film 133 formed on the surface of the carbon nanostructure 132. The protective film 133 may perform a function of protecting the carbon nanostructure 132 and preventing oxidation thereof, and may include, for example, at least one of B and Al. In this case, the protective layer 133 may be formed of a metal body of B or Al, an oxide of B or Al or combinations thereof.

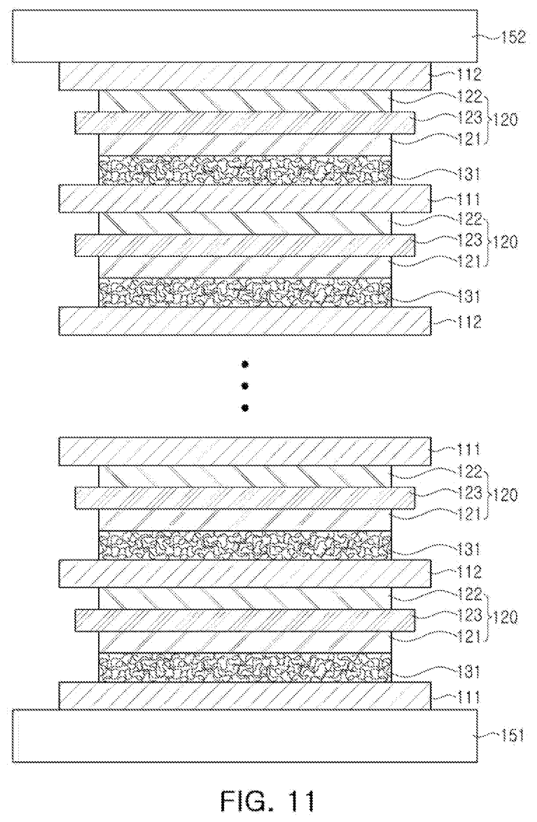

Modified examples will be described with reference to FIGS. 10 and 11. First, in a case of FIG. 10, in this example embodiment, the porous metal foam 132 is additionally disposed at the second interconnect 112. In other words, a second porous metal foam 132 is further disposed between the second interconnect 112 and the solid oxide cell 120, and in this case, the first porous metal foam 131 disposed on the side of the first interconnect 111 may be referred to as a first porous metal foam 131. The electrical connectivity and durability between the solid oxide cell 120 and the second interconnect 112 may be improved by further including the second porous metal foam 132. The second porous metal foam 132 may be driven in an oxidizing atmosphere and may be formed of a material including a Cu alloy, for example, a Cu—Mn alloy, in consideration of the driving thereof.

Next, an example embodiment of FIG. 11 further includes first and second end plates 151 and 152, and the first and second interconnects 111 and 112, the solid oxide cell 120 and the porous metal foam 131 may be disposed between the first and second end plates 151 and 152. This case may have a structure in which the first interconnect 111, the porous metal foam 131, the solid oxide cell 120, and the second interconnect 112 are sequentially and repeatedly formed two or more times, in a direction oriented from the first end plate 151 to the second end plate 152 (i.e., a direction facing upward with respect to the drawing). Accordingly, a plurality of solid oxide cells 120 may be connected in series to each other to improve an output thereof, so that the water electrolysis cell may provide a higher amount of hydrogen generation, and the fuel cell may obtain electricity having higher voltage. The first and second end plates 151 and 152 may include a metal having a high melting point so as not to be melted or softened even when the solid oxide cell 120 is driven at high temperatures, and may have a flat structure of the metal. For example, the first and second end plates 151 and 152 may include a material such as a nickel-based material, an iron-based material, or a stainless-based material. Furthermore, when an operating temperature of the solid oxide cell stack 100 is relatively low, for example, as low as 800° C. or less, copper or copper alloys having good conductivity may be used.

The present disclosure is not limited to the above-described example embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

What is claimed is:

1. A solid oxide cell stack comprising:
first and second interconnects;
a solid oxide cell disposed between the first and second interconnects; and
a porous metal foam between the first interconnect and the solid oxide cell,
wherein the porous metal foam includes a carbon nanostructure on a surface of the porous metal foam.

2. The solid oxide cell stack according to claim 1, wherein the carbon nanostructure includes at least one of carbon nanotubes or carbon nanofibers.

3. The solid oxide cell stack according to claim 1, wherein the porous metal foam comprises the carbon nanostructure on the surface of the porous metal foam, which is in contact with the solid oxide.

4. The solid oxide cell stack according to claim 3, wherein the porous metal foam comprises the carbon nanostructure on the surface of the porous metal foam, which is opposite to the surface in contact with the solid oxide.

5. The solid oxide cell stack according to claim 4, wherein the porous metal foam comprises the carbon nanostructure on the surface and an entire interior of the porous metal foam.

6. The solid oxide cell stack according to claim 1, wherein the carbon nanostructure is disposed perpendicular to the surface of the porous metal foam.

7. The solid oxide cell stack according to claim 1, wherein the carbon nanostructure is disposed in a random direction with respect to the surface of the porous metal foam.

8. The solid oxide cell stack according to claim 1, wherein the porous metal foam includes Ni.

9. The solid oxide cell stack according to claim 1, wherein the porous metal foam is an elastic body, and the porous metal foam is compressed by the first interconnect and the solid oxide cell.

10. The solid oxide cell stack according to claim 1, wherein the solid oxide cell includes a fuel electrode and an air electrode, and an electrolyte disposed between the fuel electrode and the air electrode, and the fuel electrode is disposed on a surface of the electrolyte closer to the first interconnect, and the air electrode is disposed at the second interconnect side.

11. The solid oxide cell stack according to claim 10, further comprising:
when the porous metal foam is referred to as a first porous metal foam, a second porous metal foam disposed between the second interconnect and the solid oxide cell.

12. The solid oxide cell stack according to claim 11, wherein the second porous metal foam includes a Cu alloy.

13. The solid oxide cell stack according to claim 1, further comprising:
first and second end plates,
wherein the first and second interconnects, the solid oxide cell, and the porous metal foam are disposed between the first and second end plates.

14. The solid oxide cell stack according to claim 13, wherein the solid oxide cell stack has a structure in which the first interconnect, the porous metal foam, the solid oxide cell, and the second interconnect are sequentially and repeatedly formed two or more times in a direction oriented from the first end plate to the second end plate.

15. The solid oxide cell stack according to claim 1, wherein the porous metal foam further includes a protective film disposed on a surface of the carbon nanostructure.

16. The solid oxide cell stack according to claim 15, wherein the protective layer includes at least one of B or Al.
